(19) United States
(12) Patent Application Publication
(10) Pub. No.: US 2016/0244267 A1
(43) Pub. Date: Aug. 25, 2016

(54) PRODUCT SINGULATING SYSTEM AND APPARATUS

(71) Applicant: BEAVER MACHINE CORPORATION, Newmarket (CA)

(72) Inventor: Mark Rendell, Newmarket (CA)

(21) Appl. No.: 14/911,863

(22) PCT Filed: Aug. 14, 2014
(86) PCT No.: PCT/CA2014/000621

§ 371 Date: Apr. 7, 2016

(30) Foreign Application Priority Data
Aug. 14, 2013 (CA) 2.823.591

(51) Int. Cl. B65G 37/00; B65G 15/14; G07F 11/24; G07F 11/58; G07F 11/44; B65G 11/20; B65G 47/31

(52) U.S. Cl. CPC B65G 37/00; B65G 11/203; B65G 15/14; B65G 47/31; G07F 11/58; G07F 11/44; G07F 11/24

(57) ABSTRACT

A separating and singulating system and apparatus for separating individual items from a plurality of items comprises a first conveyor for receiving and conveying the items toward an output end of the first conveyor at a first transfer rate, and a pair of auxiliary belts disposed generally in horizontal opposition above the first conveyor along at least part of the first conveyor zone, disposed in substantially the same direction and moving at substantially the same transfer rate as the first conveyor, for assisting the conveyance of the plurality of items toward the output end of the first conveyor. A second conveyor defining a second conveyor zone has an infeed end in communication with the output end of the first conveyor, and an output end for dispensing the items. The second conveyor may convey the items at a second transfer rate which is faster than the first transfer rate, so that a spacing between items in the second conveyor zone is great than a spacing between items in the first conveyor zone. A sensor may be provided to count items as they are dispensed.

### FIELD OF INVENTION

This invention relates to a singulating system and apparatus. In particular, this invention relates to a system and apparatus for separating and singulating individually wrapped items from a bulk container, and in one embodiment a vending machine incorporating the system and apparatus.

### BACKGROUND OF THE INVENTION

Separating and singulating systems for bulk products are well known. Such systems are widely used in the packaging industry, for example to fill containers with a specific metered amount of bulk product from a hopper or other container for consumer sale. In industrial applications, separating and singulating systems automate the packaging process, significantly reducing labour costs. Such systems can also reduce space requirements, since the ‘footprint’ of an automatic separating or singulating machine can be considerably smaller than a manual separating station, which must provide room for workers to position themselves about the conveyors and in order to separate the product.

Such systems are also widely used in retail dispensing apparatus such as bulk vending machines, which store bulk product in a bin and dispense a specific metered amount of the bulk product to a purchaser upon payment of a preset amount. However, there are limitations on the types of products that can be separated and singulated by conventional systems.

Some types of products are well suited for automated separation or singulation. For example, bulk vending machines often dispense gumballs, hard-walled spherical capsules containing toys or confectionaries, and other hard-shelled, relatively uniformly dimensioned (usually spherical) product. The separating mechanisms utilized for such products can be fairly straightforward, because there are no abrupt edges or uneven surfaces and the hard outer coating (whether a feature of the product itself or the package in which the product is contained) retains its size and shape through the dispensing process. For products with such a topology, automated singulation is quite reliable because the items do not change size or shape in the singulation or separation apparatus and there are no protruding or unusual surface features to get caught on the mechanical and conveying components of the singulating or separating apparatus. Therefore, the behaviour of such items in batch form is very predictable.

For such items, a separating compartment can be sized to receive a specific volume (i.e. number of units) of bulk product, and because the size and shape of the items can reliably and predictably separate the selected volume from the bulk container. A non-limiting example of a separating or singulating apparatus suitable for separating a preset volume of hard-shelled spherical items from a batch is the vending machine described and illustrated in U.S. Pat. No. 5,259,532 issued Nov. 9, 1993 to Schwarzli, which is incorporated herein by reference.

Where the bulk product is soft-shelled or non-uniformly shaped, however, separation and singulation of product items is much more difficult. For example, a soft-shelled confectionary individually wrapped in a cellophane (or other) wrapper presents significant challenges to reliable separation and singulation: separating items from a batch without damaging the soft shell of the confectionary; reliably separating a specific number of product units from the bulk supply on a continuous basis; and avoiding clumping and catching due to the non-uniform shape of the items and projecting portions of the wrapper. These problems lead to unpredictable behaviour of the items when moving through a separating, feeding or dispensing system.

On of the critical parameters of separating and singulating machinery used for such purposes is that it be continuously reliable. In order to maintain consumer confidence in an unsupervised bulk vending scenario, the purchaser must feel absolutely certain that the product for which he or she is paying will be dispensed intact and in the correct volume. A purchaser who receives damaged product ,or less than the expected quantity, is likely to never purchase goods from a bulk vender again. In an industrial context, the requirement that the stipulated volume be dispensed into the consumer package for retail sale is not only practical from a consumer satisfaction perspective, it is essential from a legal standpoint because the package must contain the specified volume or weight of product in order to comply with consumer packaging laws.

### BRIEF DESCRIPTION OF THE DRAWINGS

In drawings which illustrate embodiments of the invention by way of example only:

FIG. 1 is an exploded schematic perspective view of an embodiment of a singulating apparatus according to the invention.

FIGS. 2A and 2B are elevation views respectively of a soft wrapped confectionary item and a clump of soft wrapped confectionary items.

FIG. 3 is a side elevation of a bulk vender embodying the singulating apparatus of FIG. 1.

FIG. 4 is a partially cutaway side elevation of the bulk vender of FIG. 3.

FIGS. 5 and 6 are cross-sectional partial side elevations of the bulk vender of FIG. 3 showing the action of the agitators.

FIG. 7 is a side elevation of the bulk vender taken opposite FIG. 3.

FIG. 8 is a top plan view of the bulk vender of FIG. 3.

FIG. 9 is a perspective view of the product bin in a bulk containing an active baffle.

FIG. 10 is a schematic perspective view of an industrial embodiment of the invention for filling containers with a metered amount of product for sale.

FIG. 11 is a partial perspective view of an embodiment of the invention having guide disks for aligning product items in a row at the infeed end of the first conveyor.

FIG. 12 is a schematic side elevation of the guide disk shown in FIG. 11.

FIGS. 13 and 14 are schematic front elevations of the guide disks shown in FIG. 11.

FIG. 15 is a perspective view of a separating wheel for the industrial embodiment of FIG. 10.

FIG. 16 is a partial perspective view of the separating wheel of FIG. 15 in position over the first conveyor.

FIG. 17 is a schematic perspective view of the separating wheel of FIG. 16.

FIG. 18 is a top plan view of the separating wheel of FIG. 16.

### DETAILED DESCRIPTION OF THE INVENTION

The invention can be employed in large-scale sorting and singulating systems, for example those employed in industrial packaging plants which dispense a metered amount of product items into a container, such as consumer packaging for resale. The invention can also be employed in a dispensing apparatus, for example a bulk vender (colloquially known as a “gumball machine”) which dispenses a metered volume or number of product items to a purchaser upon payment of a specified amount.

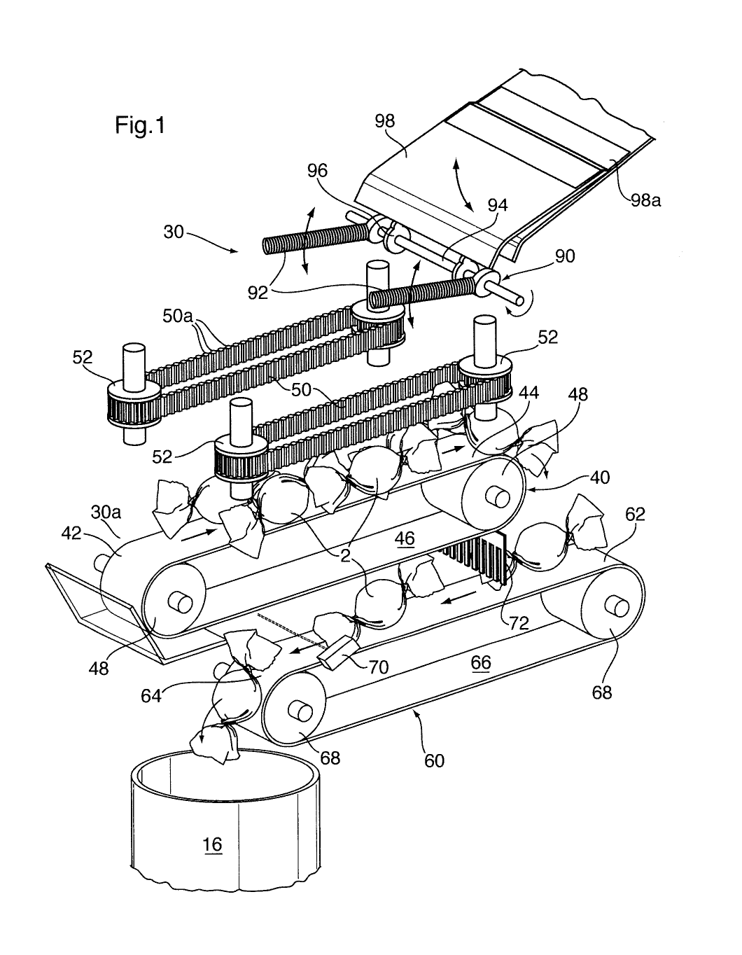

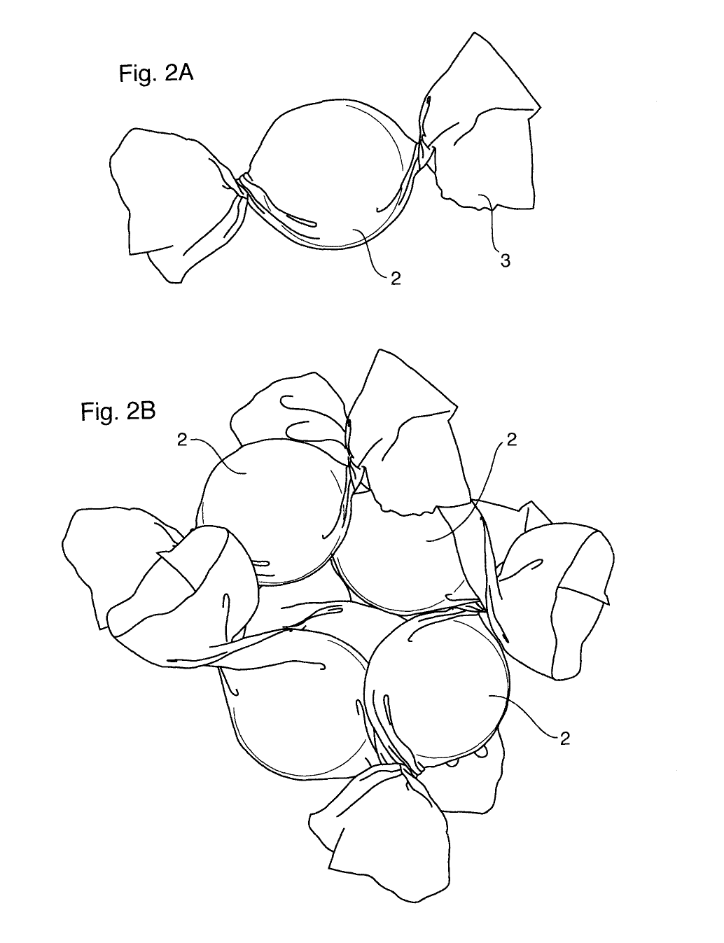

FIG. 1 illustrates an embodiment of a separating and singulating apparatus 30 according to the invention for use in a bulk vender 10, such as illustrated in FIG. 2 by non-limiting example. The bulk vender 10 illustrated has a base 12 and a product bin 14 for storing a volume of product items 2 in a batch and dispensing a predetermined volume of items 2 through a dispensing chute 16 contained within the base 12. The illustrated vender 10 could be mounted on a base 12 as a stand-alone vender, or adapted for use as a vending module in a vending kiosk such as that described in PCT patent publication no. WO2013/044364 published Apr. 4, 2013 by the present applicant, which is incorporated herein by reference, and may be mounted to the kiosk interior in the manner described therein or in any other suitable fashion.

The product illustrated in FIGS. 2A and 2B for dispensing by the vender 10 is a soft chocolate confectionary. Each confectionary item 2, best seen in FIG. 2A, is wrapped in a cellophane wrapper with twisted ‘tail’ portions 3 that render the item 2 non-uniformly shaped and provide opportunities for catching at points in the dispensing cycle. When dispensing such a product item 2, care must be taken to avoid damaging the confectionary inside the wrapper, while at the same time reliably separating a specific number of product items 2 from the bulk supply in the product bin 14. Because of the shape of each product item and the flexibility of the cellophane tails—which causes the shape of the overall item 2 to change as the item moves in a batch of items—there is a tendency for clumping to occur, as illustrated in FIG. 2B. There is also a possibility of the tail portions 3 catching on the mechanical components of the dispensing system in a conventional bulk vender.

The resulting unpredictable and unreliable dispensing behaviour in a conventional vending device such as a bulk vender is unacceptable, because a customer whose product is damaged by the dispensing mechanism or who receives fewer than the intended number of items 2 paid for will stop purchasing products from bulk venders. This issue is particularly problematic in the case of soft and/or non-uniformly shaped items 2 such as those illustrated in FIGS. 2A and 2B.

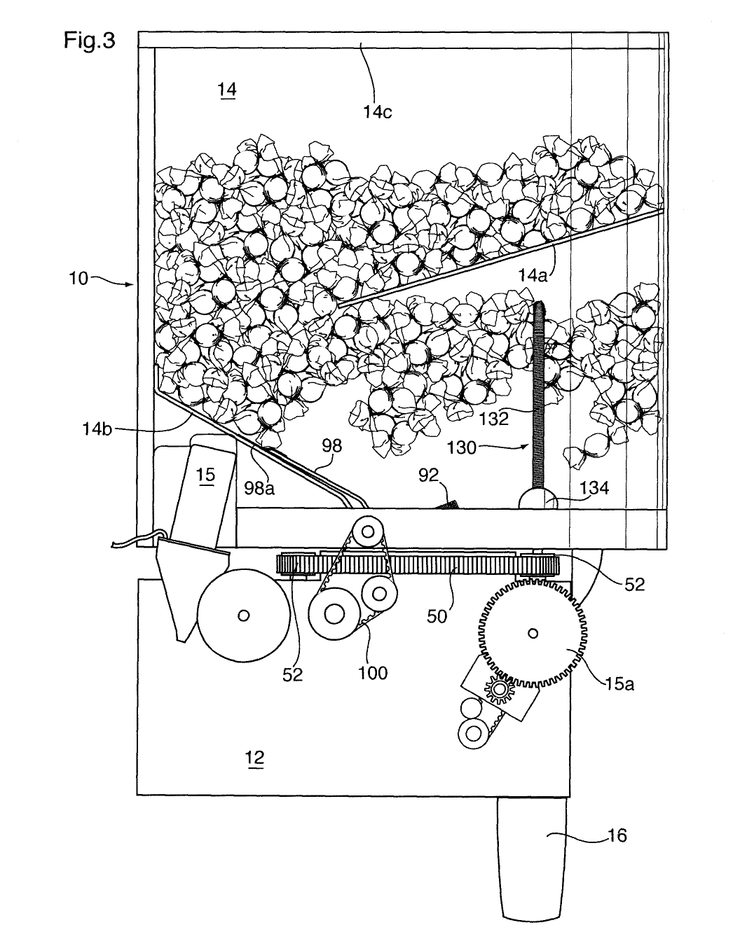

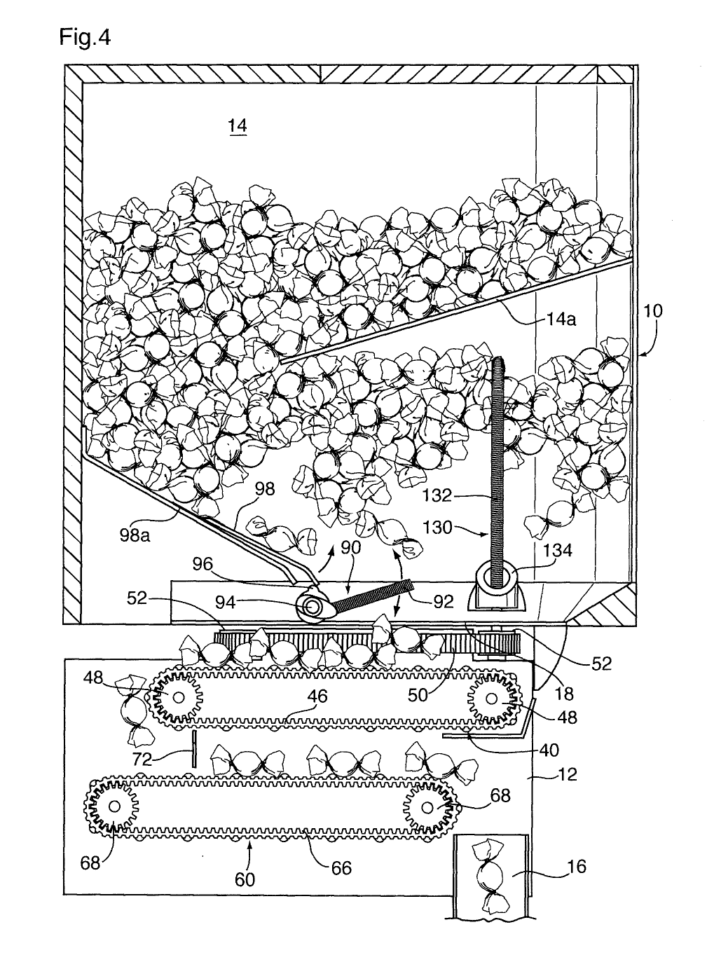

The dispensing mechanism in the vender 10 illustrated in FIGS. 3 to 8 comprises an embodiment of a singulating apparatus according to the invention. As illustrated in FIG. 1, in the preferred embodiment the singulating apparatus 30 comprises a two-stage conveyor system that progressively separates the items 2, facilitating the counting of single items 2 and ensuring the reliable metering of a preselected number of items 2 into a product dispensing chute or a container, with a very low incidence of damage to product items 2.

In the embodiment illustrated the items 2 are stored in the product bin 14, which preferably provides baffles 14a, 14b helping to direct product items 2 in the upper and intermediate portions of the product bin 14 toward the infeed end 30a of the singulating apparatus 30.

The apparatus 30 comprises a first conveyor 40 defining a first conveyor zone. The first conveyor zone extends from the infeed end 42 of the first conveyor 40 to the output end 44 of the first conveyor 40. The first conveyor 40 in the embodiment shown comprises a conveyor belt 46 advanced by frictional connection with rollers 48. The rollers 48 are in turn driven by a motor 15 contained within or mounted to the base 12 (shown in FIG. 3) with a suitable gear-down ratio for the desired speed of the conveyor through transmission 15a.

The first conveyor 40 receives a plurality of items 2 from the product bin 14, and conveys the plurality of items 2 toward the output end 44 of the first conveyor 40 at a first transfer rate. In the preferred embodiment the conveyance of items 2 though the first conveyor zone is assisted by conveyor pair of auxiliary belts 50 mounted on drive rollers 52 and disposed generally in horizontal opposition along the first conveyor 40 at a height suitable for the size of the items 2 being dispensed. One of the drive rollers 52 on each side of the first conveyor 40 is driven by the motor 15 (or by a separate motor, not shown) via a suitably geared-down transmission, for example bevel gears (not shown) driven by transmission 15a, in the same direction and at generally the same transfer rate as the first conveyor 40. The auxiliary belts 50 are formed from any suitable flexible material, preferably rubber, and are preferably provided with projections, for example vertical ribs 50a as shown, to form a moving barrier that both retains the items 2 on the first conveyor 40 and assists in urging the items 2 toward the output end 44 of the first conveyor 40.

The output end 44 of the first conveyor 40 is in communication with the infeed end 62 of a second conveyor 60 defining a second conveyor zone. In the illustrated vender 10, because of space constraints, the second conveyor 60 is disposed beneath and generally aligned with the first conveyor 40. The infeed end 62 of the second conveyor extends beyond the output end 44 of the first conveyor 40, so that items 2 dropping off the first conveyor 40 will land on the second conveyor 60.

The second conveyor 60 receives items 2 from the first conveyor 40 by any convenient means, for example by gravity feed as in the example illustrated, or alternatively via a wheel, belt or other conveyor (not shown). In the embodiment illustrated the second conveyor 60 is disposed beneath the first conveyor 40 to allow for gravity feed from the output end 44 of the first conveyor 40 to the infeed end 62 of the second conveyor 60.

To assist in separating clumped items being transferred from the first conveyor 40 to the second conveyor 60, a comb 72 may be disposed above the second conveyor 60, preferably near the infeed end 62 of the second conveyor 60. The comb 72 is spaced vertically from the second conveyor 60, leaving a clearance large enough for one item 2 lying on the second conveyor 60 to pass underneath the comb 72, but blocking any item stacked on top of or partially overlying an item 2 on the second conveyor 60. The comb 72 may be rigid, semi-rigid or flexible, as appropriate for the product being dispensed, and may be provided with semi-rigid or flexible teeth 74 which yield to a soft item 2 such as the chocolate confectionary item 2 illustrated.

The second conveyor 60 comprises a belt 66 driven by rollers 68 having an output end 64 for dispensing the items 2 into a chute 16, or into a container such as a consumer package in industrial embodiments used for metering and packaging the items 2 for consumer sale or other purposes, as described below. The second conveyor 60 may convey the items 2 at a second transfer rate which is faster than the first transfer rate, increasing the spacing between items 2 on the second conveyor 60 and thereby improving the counting and metering accuracy of the apparatus 30.

A sensor, for example an optical receiver 70, is disposed along the second conveyor 60, preferably near its output end 64, such that an item 2 passing by the sensor 70 breaks a light beam which causes a signal to be sent to a processor (not shown) that increments an item count by 1. When the item count has reached a preset number, programmable by the operator, the counter resets to zero for the next batch of items 2 to be singulated and separated from the plurality of items 2.

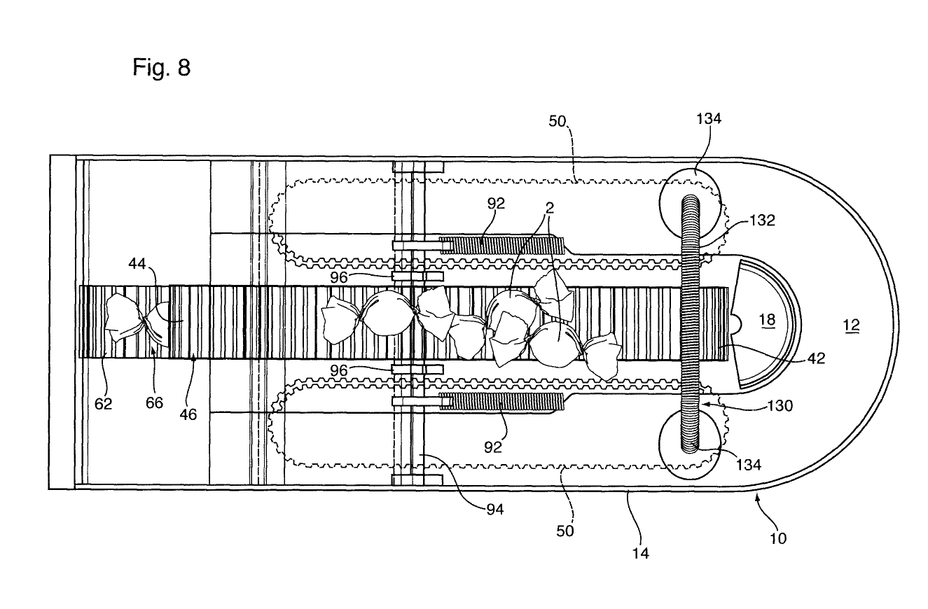

In a product bin 14 (or other type of hopper) in which product is stored in bulk and dispensed from a lower end, the weight of items 2 in the upper portions of the bin 14 restrains the motion of the items 2 in the lower portion of the bin 14. This problem is particularly acute immediately upstream of the dispensing opening 18 (best seen in FIG. 8), which forms a bottleneck that causes a build-up of items 2 in this portion of the bin 14, because the weight of the stored items 2 above bears on the next-to-be-dispensed items 2a. To alleviate this problem, in the embodiment illustrated the bin 14 is provided with baffles 14a, 14b which assist in directing items 2 toward the dispensing opening 18 by both reducing the weight on items 2 in the lower portions of the bin 14, reducing the frictional resistance to motion caused by the wieght of the items 2 above, and providing an orderly flow path toward the dispensing opening 18.

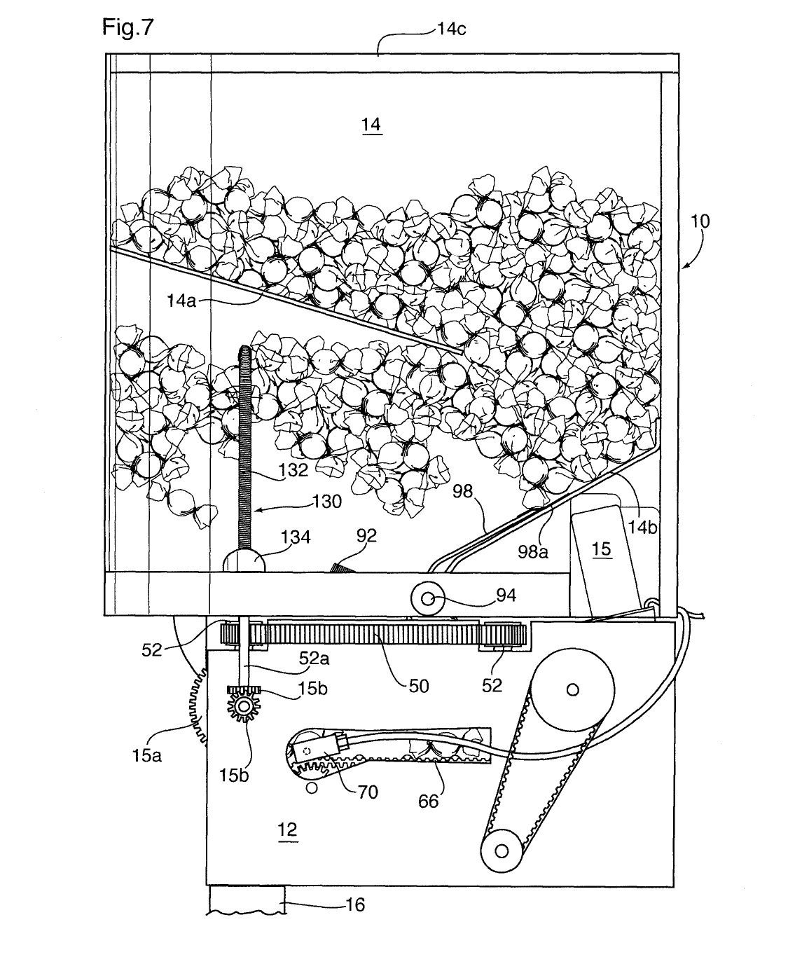

In embodiments of the invention used in the environment of a bulk vender 10, the product bin 14 optionally also contains one or more agitators for avoiding clumping of product as items 2 are dispensed and facilitating an orderly distribution of product to the infeed end 42 of the first conveyor 40. For example a loop agitator 130 comprising a resilient agitator element 132 mounted in the form of an inverted “U”, which may for example formed from a coil spring, may optionally be disposed over the dispensing opening 18 to agitate items 2 disposed in the volume of the bin 14 beneath the upper baffle 14a. The ends of the agitator element 132 in the embodiment shown are lodged in respective rotating sockets 134, driven via a suitable transmission by either the motor 15 or a separate motor (not shown). For example, the sockets 134 may be rotationally fixed to the same axle 52a that drives the belt rollers 52 on either side of the dispensing opening near the front of the vender 10 and driven by gears 15b (seen in FIG. 7), so that the agitator element 132 rotates when the auxiliary belts 50 are in motion.

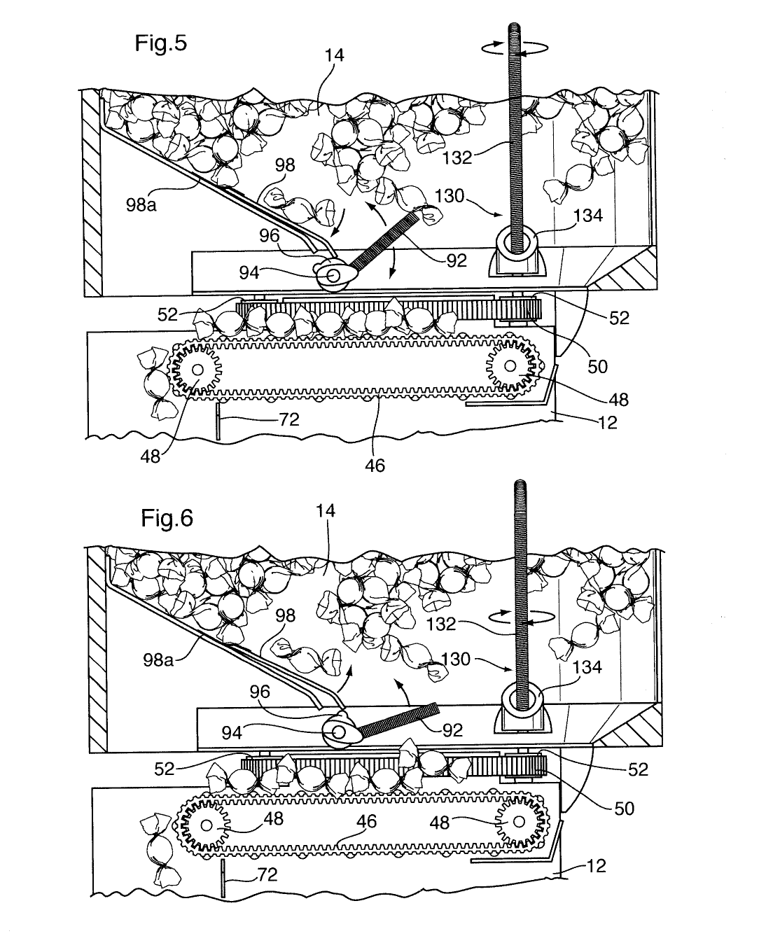

In the embodiment illustrated the vender 10 also comprises a reciprocating agitator 90, best seen in FIGS. 3 and 5, in the preferred embodiment comprising resilient agitating members 92, each for example formed from a coil spring, disposed on either side of the output end of the lower baffle 14b. The agitating members 92 may for example be rotationally fixed to an axle 94 extending through bearings (not shown) welded to or otherwise affixed to the underside of the lower baffle 14b, such that the agitating members 92 can pivot between upper and lower positions within the product bin 14, as best seen in FIGS. 5 and 6.

In the preferred embodiment the axle 94 is provided with one or more cams 96 and the output end of the lower baffle 14b is overlaid by a reciprocating plate 98, pivotally fixed to the upper surface of the baffle 14b. The plate 98 is for example affixed to the lower baffle 14b by a flexible strip 98a, which provides a smooth transition from the upper end of the lower baffle 14b to the output end of the lower baffle 14b that will not damage items 2 as they traverse the baffle 14b, while allowing the plate 98 to reciprocate toward and away from the lower baffle 14b, as shown in FIGS. 5 and 6. In the embodiment shown the plate 98 is actuated by the cams 96, and thus reciprocates concurrently with the pivoting of the agitating members 92 which in turn are driven by the motor 15 via belt assembly 100 (best seen in FIG. 3).

In operation of the embodiment of the invention implemented in a vender 10, the bin 14 is filled with product by opening the hinged lid 14c and pouring in the items 2 to be vended. Service personnel may manually agitate the items 2 in the bin 14 to maximize the holding capacity. When used as a vending module in a vending kiosk, the kiosk (not shown) provides the processor which controls the vending cycle responsive to the purchaser's payment, as is described in PCT patent publication no. WO2013/044364 published Apr. 4, 2013 by the present applicant, which is incorporated herein by reference.

When the required amount of money is provided (in cash, credit or otherwise), the user may activate the dispensing cycle of the vender 10. As the motor 15 rotates, the loop agitator 130 rotates, and the reciprocating agitator 90 and reciprocating plate 98 move in a reciprocating fashion, to agitate product within the region of the bin 14 beneath the upper baffle 14a, particularly immediately upstream of the dispensing opening 18. As a result items 2 begin to drop through the dispensing opening 18 onto the infeed end 42 of the first conveyor 40. The movement of the first conveyor 40 results in a first spacing between items 2, which travel along the first conveyor 40. Movement of the items 2 is assisted by the auxiliary belts 50, until the items 2 drop off the output end 44 onto the infeed end 62 of the second conveyor 60.

In the preferred embodiment the second conveyor 60 moves at a faster rate than the first conveyor 40, so the spacing between items 2 increases as they drop onto the second conveyor 60. Any items 2 which are stacked on one or more other items 2 are singulated at this stage the comb 72, which allows only single items to pass along the conveyor 60. As items 2 reach the drop-off point at the output end 64 of the second conveyor, they interrupt a beam of light and sensor 70 signals the processor to increment the item count by 1. Once the pre-selected number of items 2 has passed the sensor 70 and fallen into the dispensing chute 16, the processor deactivates the motor 15 and the dispensing cycle ends. The purchaser collects the product, which may be loose or optionally packaged into a container disposed beneath the dispensing chute 16, from an opening accessible to the purchaser (not shown).

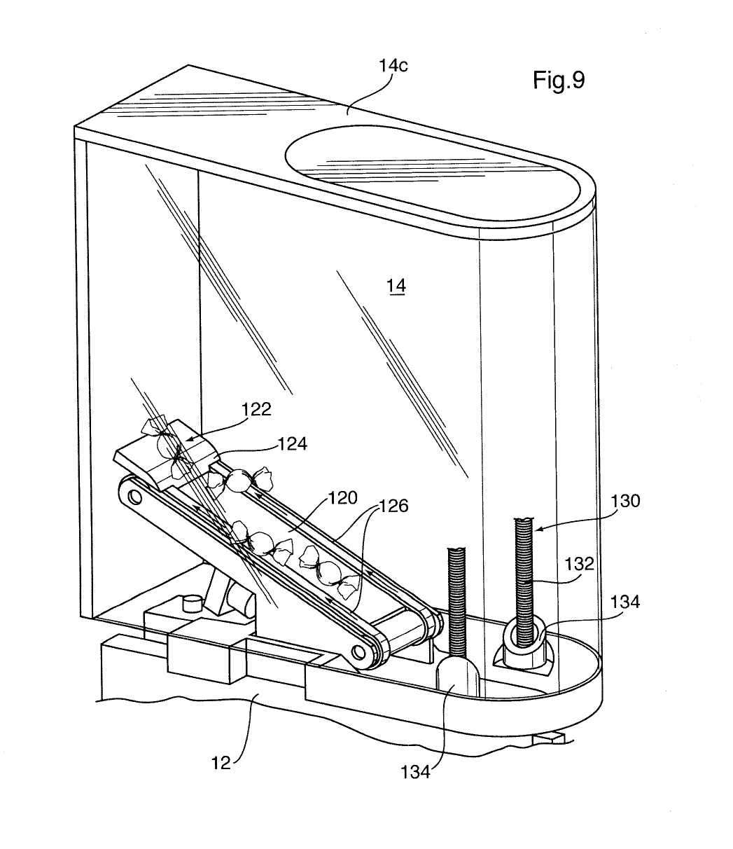

An alternative to the reciprocating plate 98 is illustrated in FIG. 9. In this embodiment the lower baffle comprises a static baffle plate 120, bounded along each side by conveyor strips 126 which during a dispensing cycle move in an upstream direction, causing items 2 on the plate 120 and touching the conveyor strips 126 to tumble toward the dispensing opening 18 under the influence of gravity while being urged upwardly by the conveyor strips 126. The influence of the conveyor strips 126 against the natural tendency for the items 2 to roll downwardly along the sloped baffle agitates the items 2 and thus avoids clustering and clumping of items 2 immediately upstream of the dispensing opening 18. A raised end block 122 may be disposed at the upper end of the baffle plate 120, having a ramped leading edge 124 which assists in agitating items 2 that settle on the baffle plate 120 in orientations that resist tumbling naturally toward the dispensing opening 18. Alternatively, the entire upper surface of the baffle plate may be covered by, or replaced by, a moving belt (not shown) which operates in the same fashion with the same effect.

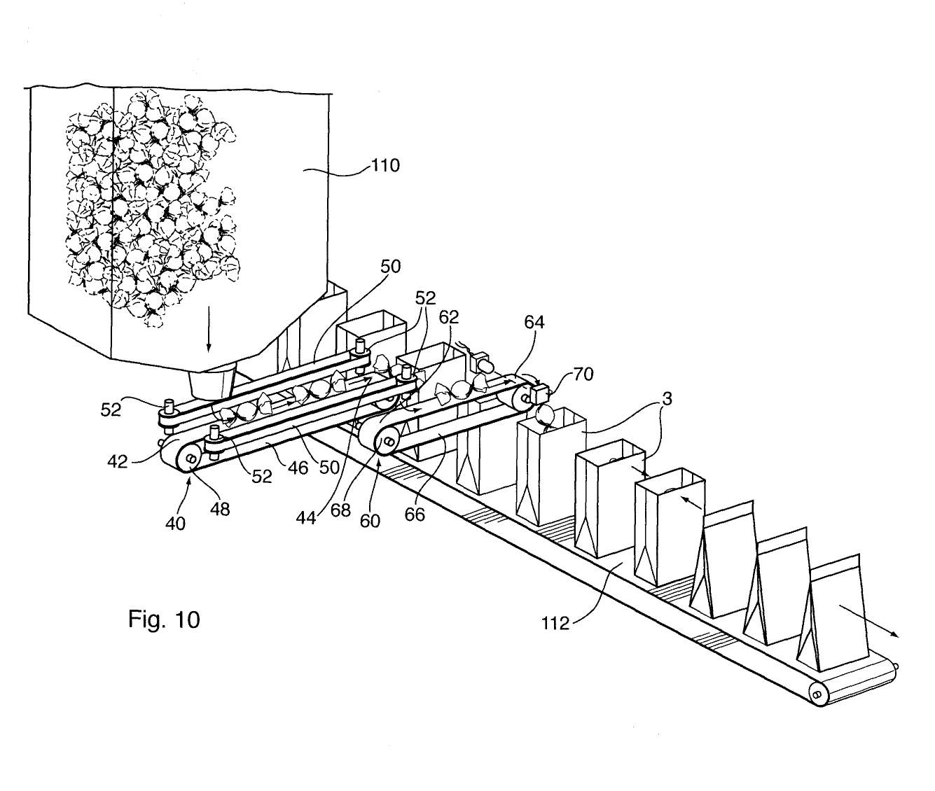

An industrial embodiment of the invention, for dispensing metered volumes of product into containers for retail sale, is illustrated in FIG. 10. In this embodiment, because there is less need to conserve space, the first conveyor 40 and the second conveyor 60 may feed in the same direction as shown. A hopper 110 dispenses product items 2 onto the infeed end 42 of the first conveyor, either directly by gravity feed as shown in FIG. 10, or by a preliminary infeed conveyor stage (not shown), or any other suitable means.

The operation of the singlulating and dispensing apparatus in FIG. 10 is otherwise substantially the same as the vender embodiment described above. The output end 64 of the second conveyor 60 deposits the singulated items into a container 3, for example a bag suitable for consumer packaging, which may be delivered into communication with the output end 64 of the second conveyor 60 by a package conveyor 112 or via any other suitable means. In the embodiment shown a sensor 70 senses the individual product items 2 as they are deposited from the output end 64 of the second conveyor 60 into the container 120, and increments a count routine in a processor (not shown). The processor is programmed to move the package conveyor 112 and reset the count routine when the desired number of items 2 has been deposited into the container 120. In other embodiments the processor may be programmed to move the package conveyor 112 when the container 3 reaches a preset weight, when the items 2 in the container 3 reach a preset level, after a preset time interval, or otherwise as desired.

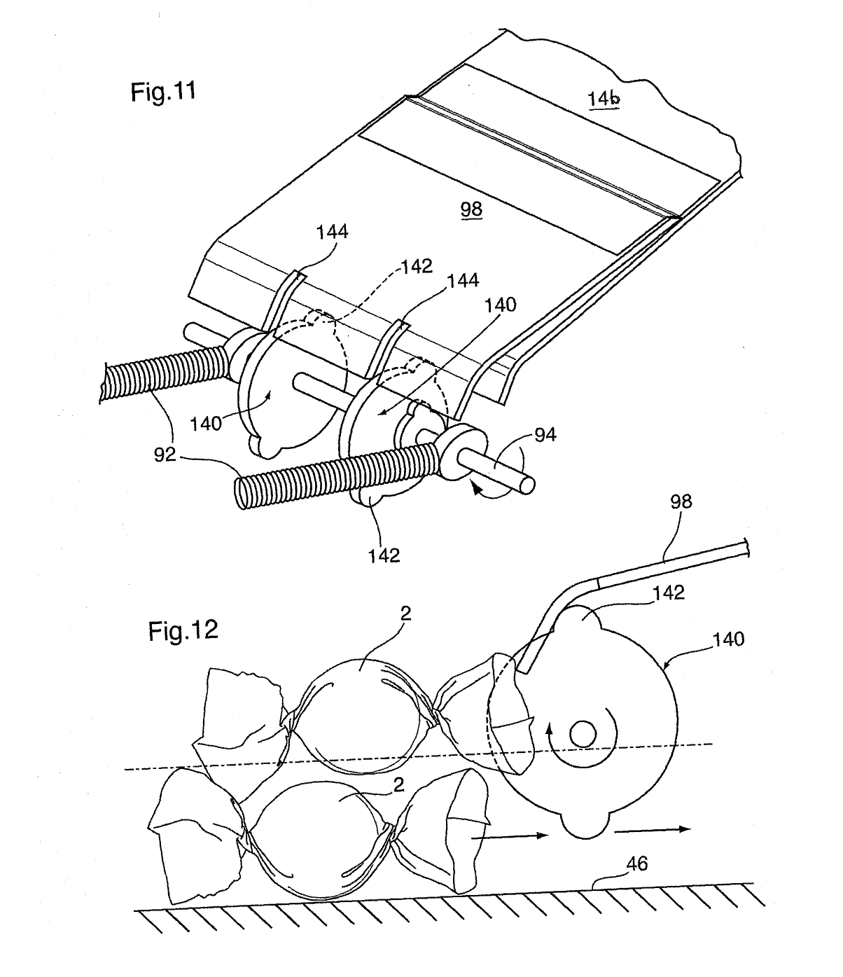

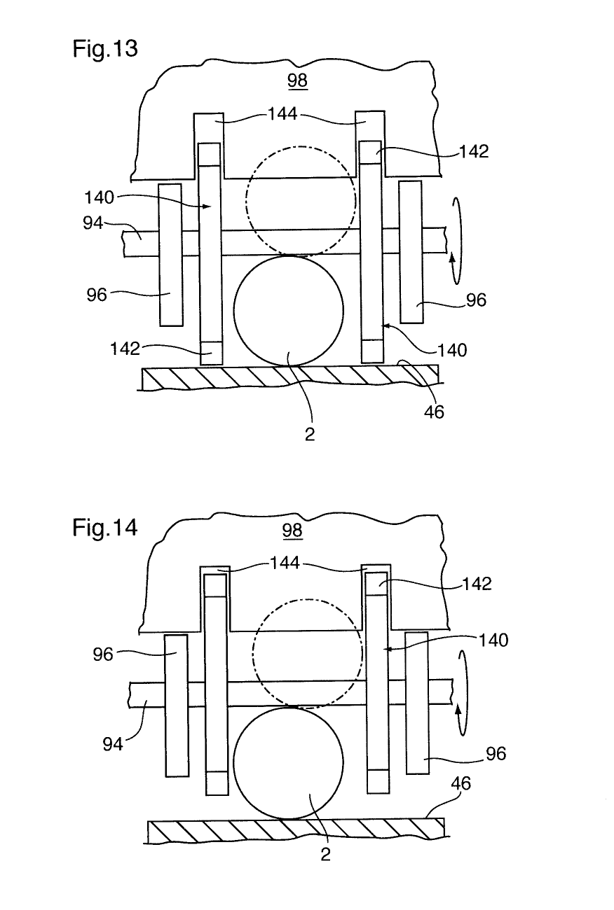

In one preferred embodiment a pair of resilient guide discs 140, for example composed of rubber or another suitable elastomer, is mounted to the axle 94. The guide discs 140 are spaced apart approximately 25% wider than the diameter of a product item 2 and serve primarily to ensure that the items 2 are generally aligned in a row as they enter the infeed end 42 of the first conveyor 40. Each guide disc 140 is preferably eccentrically mounted to the axle 94 and may provide radial projections, for example opposed bumps 142, such that rotation of the guide disks 140 provides a generally oscillating obstruction to lateral movement of the items 2 rolling off of the lower baffle 14b, as best seen in FIGS. 13 and 14. In this embodiment a pair of slots 144 is provided in the reciprocating plate 98 in alignment with the guide discs 140, allowing for the free reciprocation of plate 98 unobstructed by the guide discs 140, as best seen in FIGS. 11 and 12. As shown in FIG. 12 the guide discs 140 are rotated in a direction that tends to push an item 2 which is not lying on the conveyor belt 46 in an upstream direction, effectively separating items 2 that are in a stacked condition.

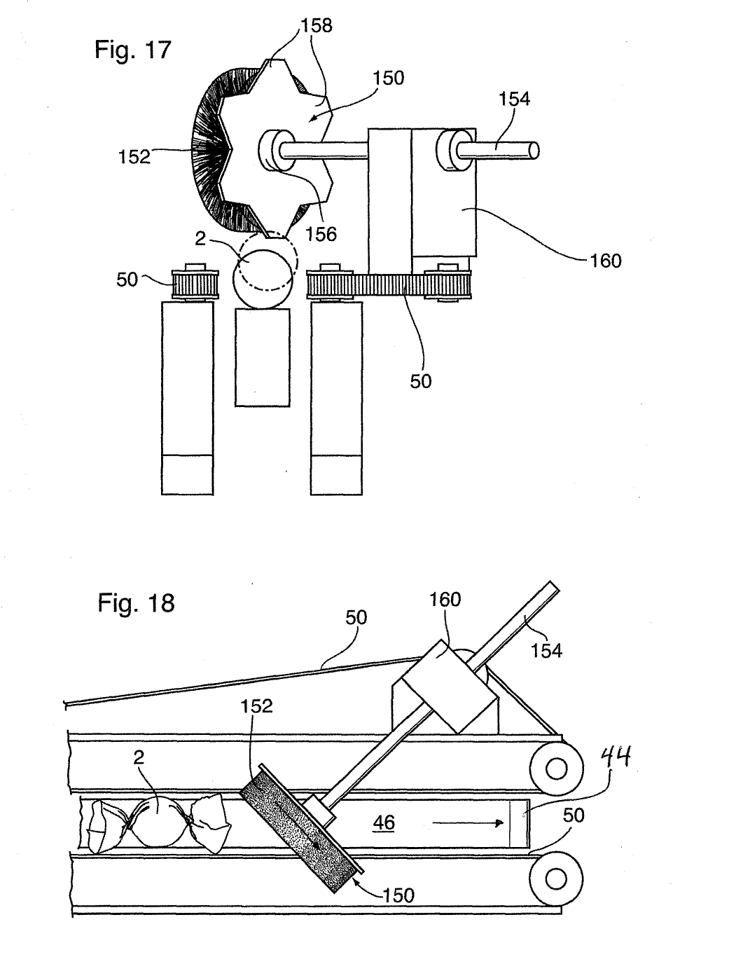

FIG. 15 illustrates a separating wheel 150 for use in the industrial singulating embodiment of FIG. 10. The separating wheel 150 comprises a nylon brush wheel 152 mounted to an axle 154 as at hub 156. The downstream face of the separating wheel 150 is preferably provided with a thin rubber overlay comprising series of resilient radial projections 158, for example forming a star wheel as best seen in FIG. 17. The projections 158 are relatively thin and yield easily when contacting by a product item 2, so as not to damage the item 2. The separating wheel 150 is mounted over the first conveyor 40, preferably at an obligue angle relative to the conveyor belt 46, and is spaced from the conveyor belt 46 so that the outer tip of a projection 158 passes slightly above the maximum height of the item 2, as shown in FIG. 17.

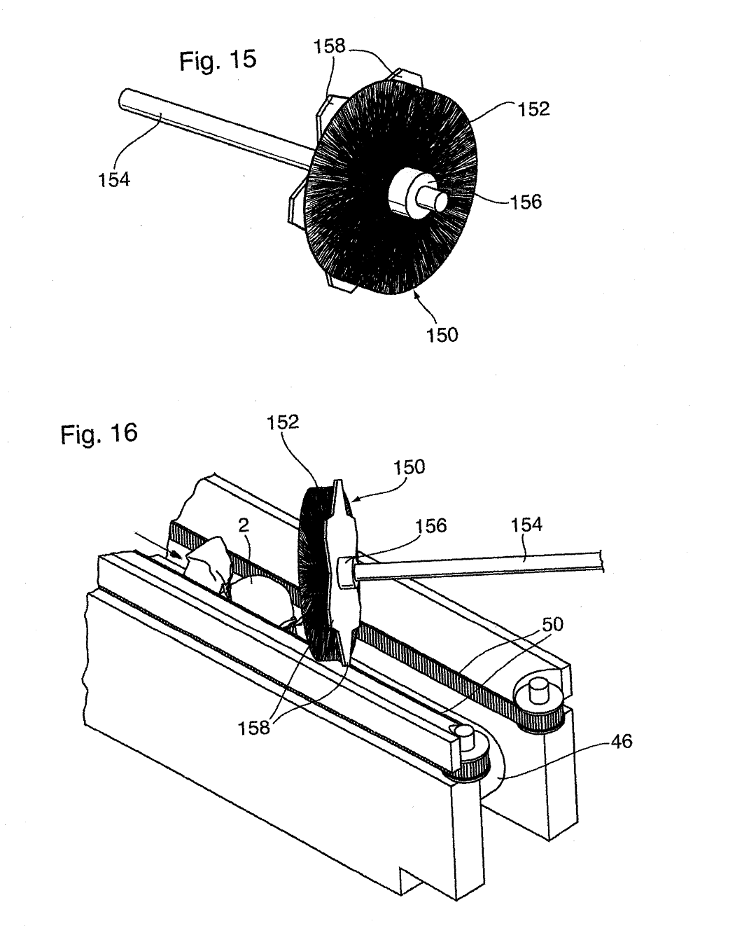

The separating wheel 150 may be driven by the same motor driving the auxiliary belts 50, and may be driven by one of the auxiliary belts 150 itself as shown in FIG. 17, via transmission 160 which allows the rotational speed of the separating wheel 150 to be different than the speed of the belts, preferably faster. As shown in FIG. 18 the separating wheel 150 is rotated in a direction that tends to push an item 2 which is not lying on the conveyor belt 46 in the upstream direction. This essentially agitates the items 2 as they travel along the conveyor 40, to ensure that all items are lying on the conveyor belt 46 when the output end 44 is reached. The nylon brush wheel 152 will gently arrange the product items 2 (as shown in FIG. 16) against the conveyor belt 46 as the items 2 travel forward. If any clustered product items 2 that advance along the first conveyor 40 do not separate and lay flat on the conveyor belt 46 under the gentler agitation pressure from the nylon brush wheel 152, then the more aggressive star wheel 158 will reposition the product items 2 with a “lifting” or “flicking” motion as the star wheel 158 rotates. Since the auxiliary belts 50 are spaced apart less than two diameters of the items, the separating wheel 150 works with the auxiliary belts 50 to ensure that the items are generally aligned in a row as they enter the output end 44 of the first conveyor 40.

Embodiments of the present invention having been described in detail by way of example, it will be apparent to those skilled in the art that variations and modifications may be made without departing from the invention. The invention includes all such variations and modifications as fall within the scope of the claims.

1. A singulating system for separating individual items from a plurality of items, comprising
a first conveyor defining a first conveyor zone, for receiving the plurality of items and conveying the plurality of items toward an output end of the first conveyor zone,
a second conveyor defining a second conveyor zone, having an infeed end in communication with the output end of the first conveyor for receiving the items from the first conveyor, and an output end for dispensing the items, and
a pair of auxiliary belts is disposed generally in horizontal opposition above the first conveyor along at least part of the first conveyor zone, in substantially the same direction and at substantially the same transfer rate as the first conveyor, for assisting the conveyance of the plurality of items toward the output end of the first conveyor.

2. The system of claim 1 wherein the second conveyor is disposed beneath and generally aligned with the first conveyor.

3. The system of claim 1 wherein the first conveyor conveys the plurality of items toward an output end of the first conveyor zone at a first transfer rate and the second conveyor conveys the items at a second transfer rate which is faster than the first transfer rate, whereby a spacing between the items in the second conveyor zone is greater than a spacing between the items in the first conveyor zone to thereby facilitate the separation of individual items from the plurality of items.

4. The system of claim 1 wherein a blocking member is disposed above and spaced from the second conveyor, leaving a clearance large enough for one item to pass underneath the blocking member.

5. The system of claim 1 wherein a sensor is disposed along the second conveyor, such that an item passing the sensor causes a signal to be sent to a processor that increments an item count.

6. The system of claim 1 contained within a bulk vender and interposed between a product bin storing the items and a dispensing opening of the vender.

7. The system of claim 6 wherein the bin is provided with baffles which assist in directing the items toward the dispensing opening.

8. The system of claim 6 wherein the bin contains at least one agitator which agitates the items in the bin as the items are dispensed to the first conveyor.

9. The system of claim 8 wherein the at least one agitator comprises a resilient agitator element rotated to agitate the items around the resilient agitator.

10. The system of claim 8 wherein the at least one agitator comprises a reciprocating plate disposed upstream of the dispensing opening.

11. The system of claim 10 wherein the reciprocating plate is associated with linear agitators that reciprocate toward and away from the dispensing opening as the reciprocating plate reciprocates.

12. The system of claim 8 wherein the at least one agitator comprises a baffle plate comprising at least one conveyor strip moving in an upstream direction, to thereby cause items touching the at least one conveyor strip to tumble toward the dispensing opening.

13. A method for separating individual items from a plurality of items, comprising the steps of:
a. in any order,
i. delivering the plurality of items to a first conveyor defining a first conveyor zone;
ii. activating a conveyor supporting the plurality of items to move the plurality of items toward an output end of the first conveyor zone;
iii. activating auxiliary belts mounted on drive rollers 52 and disposed generally in horizontal opposition along the first conveyor, to urge the items toward the output end of the first conveyor,
b. delivering the plurality of items to a second conveyor defining a second conveyor zone;
c. conveying the plurality of items to an output end of the second conveyor; and
d. dispensing the plurality of items from the output end of the second conveyor.

14. The method of claim 13 wherein the second conveyor is disposed beneath and generally aligned with the first conveyor.

15. The method of claim 13 wherein a pair of auxiliary belts is disposed generally in horizontal opposition above the first conveyor along at least part of the first conveyor zone to perform step a.(iii).

16. The method of claim 13 comprising in step d. the substeps of:
b.(i) sensing an item being conveyed along the second conveyor; and
b.(ii) sending a signal to a processor to increment an item count.

17. The method of claim 13 performed within a bulk vender to singulate the items being dispensed from a product bin in the vender and dispense the items through a dispensing opening.

18. The method of claim 17 comprising, before step a., the step of directing the items toward the dispensing opening via baffles contained within the bin.

19. The method of claim 17 comprising, before step a., the step of agitating the items in the bin as they are directed to the first conveyor.

20. The method of claim 19 comprising the step of reciprocating a plate associated with at least one baffle.
